(19) United States
(12) Patent Application Publication
(10) Pub. No.: US 2026/0291022 A1
(43) Pub. Date: Sep. 24, 2026

(54) SECONDARY BATTERY CELL

(71) Applicant: SK ON CO., LTD., Seoul (KR)

(72) Inventors: Jae-Sik SHIN, Daejeon (KR); Jae-Gyu BYUN, Daejeon (KR); Seung-Hoon JU, Daejeon (KR); Gi-Jeong SEO, Daejeon (KR)

(21) Appl. No.: 18/868,785

(22) PCT Filed: Jun. 9, 2023
(86) PCT No.: PCT/KR2023/007966

§ 371 Date: Nov. 25, 2024

(30) Foreign Application Priority Data
Jun. 15, 2022 (KR) 10-2022-0072823
Jun. 15, 2022 (KR) 10-2022-0072824
May 24, 2023 (KR) 10-2023-0066673

(51) Int. Cl. H01M 50/533; H01M 50/103; H01M 50/15; H01M 50/186; H01M 50/209; H01M 50/474; H01M 50/557

(52) U.S. Cl. CPC H01M 50/533; H01M 50/103; H01M 50/15; H01M 50/186; H01M 50/209; H01M 50/474; H01M 50/557

(57) ABSTRACT

A secondary battery cell according to one embodiment of the present invention comprises: a case for forming an inner space; an electrode assembly which includes an anode plate, a cathode plate, and a separator interposed between the anode plate and the cathode plate, and which is arranged in the inner space; and a cap plate assembly coupled to at least one side of the case, wherein the electrode assembly can comprise an anode tab and a cathode tab that extend in one direction from the anode plate and the cathode plate, respectively, and the cap plate assembly is electrically connected to the anode tab or the cathode tab and can include a connection member having an elastic part.

### TECHNICAL FIELD

The present disclosure relates to a secondary battery cell.

### BACKGROUND ART

Recently, demand for secondary batteries as an energy source has been rapidly increasing.

A secondary battery refers to a battery in which the mutual conversion between chemical energy and electrical energy is reversible, so that charging and discharging may be repeated.

A secondary battery may include an electrode assembly in which a cathode plate, an anode plate, and a separator interposed between the cathode plate and the anode plate are repeatedly stacked, and a case that accommodates the electrode assembly. In addition, depending on the shape of the case, the secondary battery may further include a cap plate assembly coupled to the electrode assembly by welding to seal the case.

For example, an electrode uncoated portion of the electrode assembly may be joined to a current collector by welding, and the current collector may be joined to the cap plate assembly by welding. In particular, in the structure in which the current collector is connected to the rivet of the cap plate assembly as in the related art, there was a possibility of defects occurring because welding was reflected heavily in the sealing portions.

### SUMMARY OF INVENTION

### Technical Problem

An aspect of the present disclosure is to provide a secondary battery cell in which a welding process is simplified when sealing a case.

### Solution to Problem

According to an aspect of the present disclosure, a secondary battery cell includes a case forming an internal (inner) space; an electrode assembly including an anode plate, a cathode plate, and a separator interposed between the anode plate and the cathode plate, and disposed in the internal space; and a cap plate assembly coupled to at least one side of the case, wherein the electrode assembly includes an anode tab and a cathode tab extending in one direction from the anode plate and the cathode plate, respectively, and the cap plate assembly includes a connection member electrically connected to the anode tab or the cathode tab, and including an elastic part.

According to an embodiment of the present disclosure, the elastic part may have elasticity in a direction in which the cap plate assembly is coupled to the case.

According to an embodiment of the present disclosure, the elastic part may be provided as one or more coil springs or plate springs.

According to an embodiment of the present disclosure, the cap plate assembly may include a cap plate coupled to the case; a terminal plate disposed on one side of the cap plate; and an insulating plate disposed on at least one side of one surface and the other surface of the cap plate, and the connection member may be disposed to penetrate through the cap plate, the terminal plate, and the insulating plate.

According to an embodiment of the present disclosure, the terminal plate may be electrically connected to the anode tab or the cathode tab through the connection member.

According to an embodiment of the present disclosure, the connection member may include a first portion forming contact with the elastic part and the terminal plate.

According to an embodiment of the present disclosure, the connection member may further include a second portion forming contact with the elastic part and the anode tab or the cathode tab.

According to an embodiment of the present disclosure, the cap plate assembly may further include a sealing member disposed between the cap plate and the connection member.

According to an embodiment of the present disclosure, the cap plate, the terminal plate, and the insulating plate may include a through-hole in which the connection member is disposed, and the connection member may be fitted into the through-hole.

According to an embodiment of the present disclosure, the cap plate assembly may include a first cap plate assembly disposed on one side of the case in a longitudinal direction and including a first terminal plate electrically connected to the anode tab; and a cap plate assembly disposed on the other side of the case in the longitudinal direction and including a second terminal plate electrically connected to the cathode tab.

### Advantageous Effects of Invention

A secondary battery cell according to an embodiment of the present disclosure has a simplified manufacturing process since the number of welding operations required for case sealing is reduced, and defects caused by welding may be minimized.

### BRIEF DESCRIPTION OF DRAWINGS

FIG. 1 is a perspective view of a secondary battery cell according to an embodiment of the present disclosure.

FIG. 2 is a schematic exploded perspective view of a secondary battery cell according to an embodiment of the present disclosure.

FIG. 3 is a longitudinal cross-sectional view of a secondary battery cell according to an embodiment of the present disclosure.

FIG. 4 is a drawing illustrating before and after a cap plate assembly illustrated in FIG. 3 is coupled.

FIG. 5 is a longitudinal cross-sectional view of a secondary battery cell according to another embodiment of the present disclosure.

FIG. 6 is a drawing illustrating before and after a cap plate assembly illustrated in FIG. 5 is coupled.

FIG. 7 is a drawing schematically illustrating an energy storage device including a secondary battery cell according to an embodiment of the present disclosure.

### BEST MODE FOR INVENTION

Hereinafter, embodiments of the present disclosure will be described in detail with reference to the drawings. However, the idea of the present disclosure is not limited to the presented embodiments.

For example, those skilled in the art who understand the idea of the present disclosure will be able to easily suggest other embodiments included within the scope of the idea of the present disclosure through addition, modification, deletion of components, or the like, but this will also be included within the scope of the idea of the present disclosure.

In the following description, when it is said that a configuration is “connected” to another configuration, it means not only that these configurations are “directly connected”, but also that they are “indirectly connected” with another configuration therebetween. In addition, “including” a component means that other components may be included rather than excluding other components unless specifically stated otherwise.

In addition, terms including ordinal numbers such as “first,” “second,” and the like used in this specification may be used to describe various components, but the components are not limited by the terms, and the terms are used only for the purpose of distinguishing one component from another. For example, without departing from the scope of the present disclosure, the first component may be referred to as the second component, and similarly, the second component may also be referred to as the first component.

Hereinafter, a secondary battery cell according to embodiments of the present disclosure will be described with reference to the attached drawings.

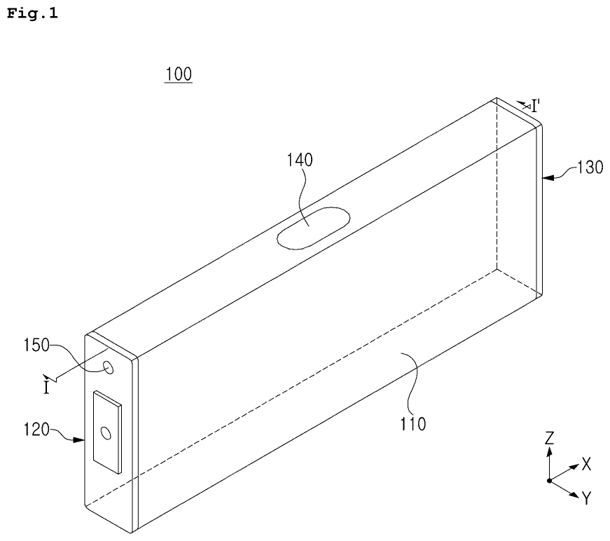

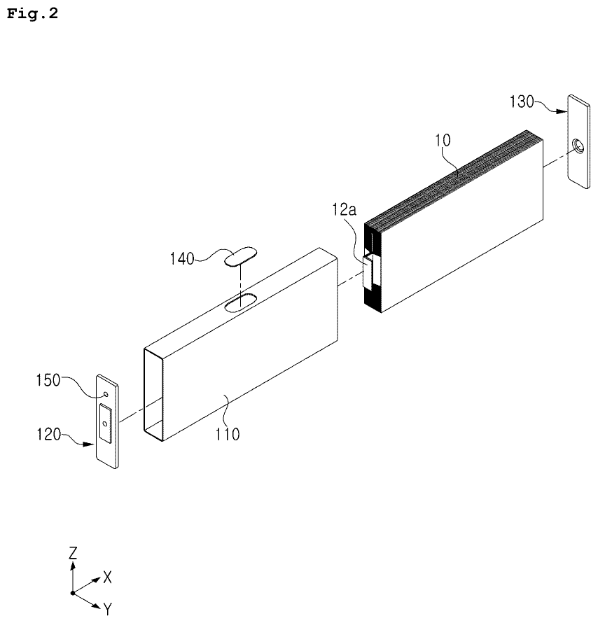

FIG. 1 is a perspective view of a secondary battery cell according to an embodiment of the present disclosure, and FIG. 2 is a schematic exploded perspective view of a secondary battery cell according to an embodiment of the present disclosure.

As illustrated in the drawings, a secondary battery cell (100) according to an embodiment of the present disclosure may be a prismatic secondary battery cell, and may include a case (110), a first cap plate assembly (120), a second cap plate assembly (130), and a venting portion (140).

The case (110) may form the exterior of the secondary battery cell (100), and may be made of aluminum or a material including aluminum. However, the material of the case (110) is not limited thereto. In addition, since the secondary battery cell (100) of the present disclosure is a prismatic type, the case (110) may have a flat and angular shape.

The case (110) may accommodate an electrode assembly (10) and an electrolyte (not illustrated) therein. The electrode assembly (10) may include an anode plate, a cathode plate, and a separator that is an insulator interposed between the anode plate and the cathode plate. The electrode assembly (10) may be provided as a stack type in which anode plates, cathode plates, and separators are alternately stacked, or as a jelly roll type in which stacked anode plates, cathode plates, and separators are rolled together.

The first and second cap plate assemblies (120 and 130) may be coupled to the case (110). For example, the secondary battery cell (100) may have a double-end tab structure in which electrode tabs are disposed on both ends of the case (100), respectively. In the case of the double-end tab structure, as illustrated in the attached drawing, the first and second cap plate assemblies (120 and 130) may be respectively coupled to both sides of the case (110) in the longitudinal direction.

The anode plate and the cathode plate may respectively be a current collector coated with an anode active material or a cathode active material. For example, the anode plate may be a current collector made of copper or nickel, coated with graphite or the like, and the cathode plate may be a current collector made of aluminum, coated with a transition metal oxide active material.

In addition, the anode plate and the cathode plate may include an uncoated portion where the anode active material or the cathode active material is not coated on both-end portions of the current collector in the longitudinal direction, and the uncoated portions of the anode plate may be connected to each other to form an anode tab (12a), and the uncoated portions of the cathode plate may be connected to each other to form a cathode tab (13a).

In this specification, the secondary battery cell (100) having a double-end tab structure in which a cap plate assembly is coupled to each of both sides of the case (110) in the longitudinal direction is mainly described, but as another example, the secondary battery cell (100) may include a single cap plate assembly, and the single cap plate assembly may be coupled to one side of the case (110) in the height direction.

In addition, as illustrated in the drawings, the venting portion (140) may be coupled to the case (110). The venting portion (140) may be configured to discharge gas or the like generated inside the case (110). For example, the venting portion (140) may be configured to be ruptured when the internal pressure of the case (110) increases due to gas or the like. Meanwhile, the venting portion (140) may also be coupled to a cap plate, a component of the cap plate assembly, in addition to the case (110).

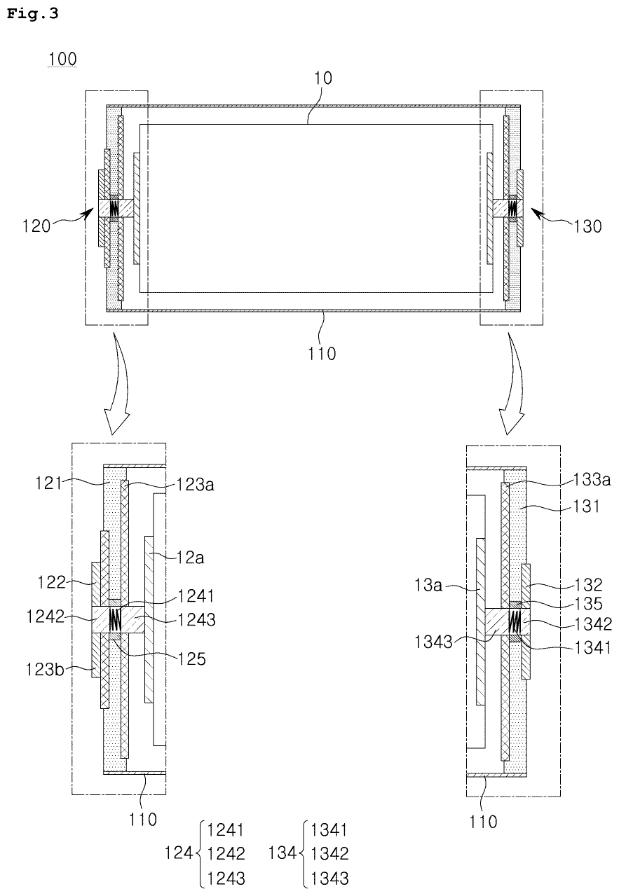

Next, a cap plate assembly according to embodiments of the present disclosure will be described with reference to FIGS. 3 to 6.

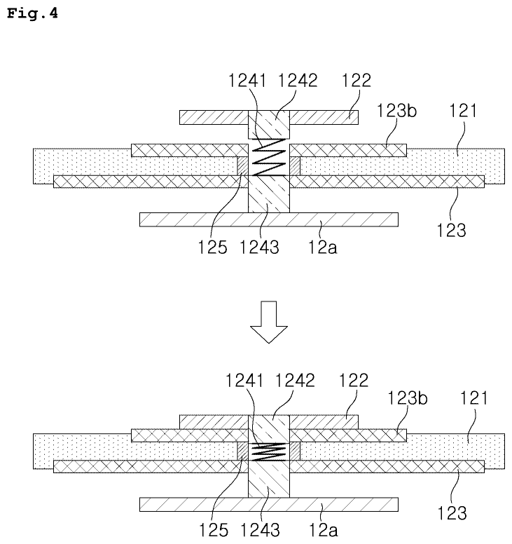

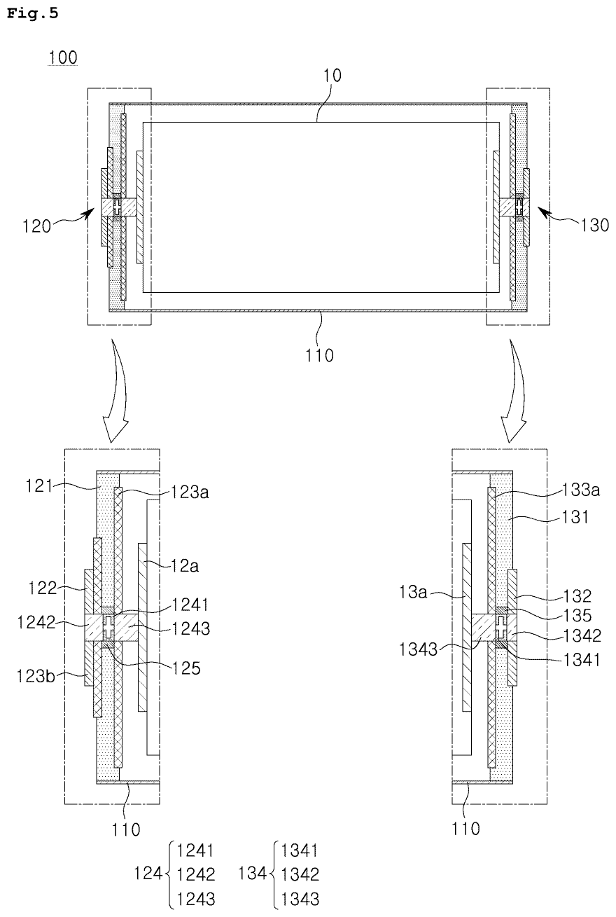

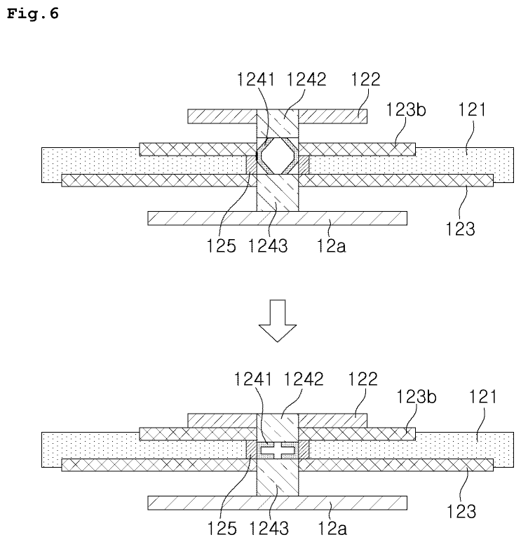

FIG. 3 is a longitudinal cross-sectional view of a secondary battery cell according to an embodiment of the present disclosure, FIG. 4 is a drawing illustrating before and after coupling of the cap plate assembly illustrated in FIG. 3, FIG. 5 is a longitudinal cross-sectional view of a secondary battery cell according to another embodiment of the present disclosure, and FIG. 6 is a drawing illustrating before and after coupling of the cap plate assembly illustrated in FIG. 5.

The first and second cap plate assemblies (120 and 130) may be coupled to both sides of the case (110) in the longitudinal direction, respectively. For example, the secondary battery cell (100) may have an anode tab and a cathode tab on both sides thereof in the longitudinal direction, and the first and second cap plate assemblies (120 and 130) may be electrically connected to the anode tab or the cathode tab, respectively, while being coupled to the case (110). Accordingly, among constituent elements of the first and second cap plate assemblies (120 and 130), constituent elements formed of a conductive material may be charged with an anode or a cathode. In embodiments of the present disclosure, the first cap plate assembly (120) may include negatively charged components, and the second cap plate assembly (130) may include positively charged components.

Referring to FIGS. 3 and 5, the first and second cap plate assemblies (120 and 130) according to embodiments of the present disclosure may include first and second cap plates (121 and 131), first and second terminal plates (122 and 132), first and second insulating plates (123 and 133), first and second connection members (124 and 134), and first and second sealing members (125 and 135), respectively. The first and second cap plate assemblies (120 and 130) may be coupled to the case (110) in a state in which the components are assembled.

The first and second cap plates (121 and 131) are components that are directly coupled to the case (110) in the first and second cap plate assemblies (120 and 130), and may be formed of aluminum or a material including aluminum. To couple the first and second cap plate assemblies (120 and 130) to the case (110), laser welding may be performed along the edge portions of the first and second cap plates (121 and 131).

The first and second terminal plates (122 and 132) may be disposed on one sides of the first and second cap plates (121 and 131). For example, the first and second terminal plates (122 and 132) may be disposed on opposite sides of the surfaces of the first and second cap plates (121 and 131) facing the interior space of the case (110). In addition, the first and second terminal plates (122 and 132) may be electrically connected to the anode tab and the cathode tab, respectively, and may be charged with an anode or cathode. For example, the first terminal plate (122) may be charged with an anode, and the second terminal plate (132) may be charged with a cathode.

The first and second insulating plates (123 and 133) may be disposed on at least one sides of the first and second cap plates (121 and 131). For example, the first insulating plate (123) may be disposed on one side and the other side of the cap plate (121), and the second insulating plate (133) may be disposed on only one side of the cap plate (131). In more detail, the first insulating plate (123) of the first cap plate assembly (120) may include a first inner insulating plate (123a) disposed on one surface (inner side surface) of the first cap plate (121) and a first outer insulating plate (123b) disposed on the other surface (outer side surface) of the first cap plate (121), and the first outer insulating plate (123b) may be disposed between the first cap plate (121) and the first terminal plate (122). On the other hand, the second insulating plate (133) of the second cap plate assembly (130) may only include a second inner insulating plate (133) disposed on one side (inner side side) of the second cap plate (131), and no insulating plate may be disposed between the second cap plate (131) and the second terminal plate (132).

In this regard, the first and second cap plates (121 and 131) may include mounting grooves in which the first and second insulating plates (123 and 133) are mounted. For example, since the first insulating plates (123a, 123b) are disposed on one side and the other side of the first cap plate (121), the first cap plate (121) may include mounting grooves on both sides thereof. On the other hand, since the second insulating plate (133) is disposed only on one side of the second cap plate (131), the second cap plate (131) may include a mounting groove on one side thereof. In addition, similarly, the first outer insulating plate (123b) may include a mounting groove on one side so that the first terminal plate (122) is disposed, and the first terminal plate (122) may be mounted in the mounting groove of the first outer insulating plate (123b).

The first and second connection members (124 and 134) may be disposed to penetrate the first and second cap plates (121 and 131), the first and second terminal plates (122 and 132), and the first and second insulating plates (123 and 133) as illustrated in the drawing. For example, the first and second cap plates (121 and 131), the first and second terminal plates (122 and 132), and the first and second insulating plates (123 and 133) may respectively include a hole, and the respective holes may be disposed to overlap each other to form one through-hole. The first and second connection members (124 and 134) may be fixedly disposed in the through-holes in a force-fit manner.

One ends of the first and second connection members (124 and 134) may be brought into contact with the anode tab (12a) or the cathode tab (13a) by passing through the through-holes from sides of the first and second terminal plates (122 and 132) disposed on the outermost sides of the first and second cap plate assemblies (120 and 130). In addition, while the first and second connection members (124 and 134) are inserted into the through-holes, the other ends of the first and second connection members (124 and 134) may be brought into contact with the first and second terminal plates (122 and 132). That is, the first and second terminal plates (122 and 132) may be structurally connected to two end tabs (12a and 13a) through the first and second connection members (124 and 134). Furthermore, since the first and second connection members (124 and 134) are formed of a conductive material, the first and second terminal plates (122 and 132) may be electrically connected to the two end tabs (12a and 13a) and charged with a anode or cathode. The first and second connection members (124 and 134) may provide a path for current to flow.

According to embodiments of the present disclosure, the first and second connection members (124 and 134) may be provided in a rivet type or a pin type. In addition, according to embodiments of the present disclosure, the first and second connection members (124 and 134) may include elastic parts (1241 and 1341). For example, the elastic parts (1241 and 1341) may be provided in a coil spring or a plate spring. The elastic parts (1241 and 1341) may have elasticity in the longitudinal direction of the case (110) (or in the coupling direction of the first and second cap plate assemblies (120 and 130)).

According to an embodiment of the present disclosure, the elastic parts (1241 and 1341) may be applied to the middle portions of the first and second connection members (124 and 134). For example, the first and second connection members (124 and 134) include first portions (1242 and 1342) that contact the first and second terminal plates (122 and 132), and second portions (1243 and 1343) that contact the two end tabs (12a and 13a), and the elastic parts (1241 and 1341) may be provided between the first portions (1242 and 1342) and the second portions (1243 and 1343). In another embodiment, the first and second connection members (124 and 134) may include first portions (1242 and 1342) that contact the first and second terminal plates (122 and 132) and elastic parts (1241 and 1341), and the second portions (1243 and 1343) may be provided on sides of the two end tabs (12a and 13a). In this case, the elastic parts (1241 and 1341) may be in contact with the second portions (1242 and 1342).

The first and second sealing members (125 and 135) may be disposed in the through-holes and may surround portions of the first and second connection members (124 and 134) that are fitted into the through-holes. For example, the first and second sealing members (125 and 135) may be placed in holes formed in the first and second cap plates (121 and 131) and may surround portions of the first and second connection members (124 and 134) placed in the corresponding holes. The first and second sealing members (125 and 135) may be formed of an elastic and insulating material. The first and second sealing members (125 and 135) may seal the through-holes and electrically insulate the first and second connection members (124 and 134) from the cap plates (121 and 131).

The first and second cap plate assemblies (120 and 130) described above may be assembled by placing the first and second sealing members (124 and 134) in holes formed in the first and second cap plates (121 and 131), placing first and second terminal plates (122 and 132) and first and second (inner) insulating plates (123 and 133) on one surfaces and the other surfaces of the first and second cap plates (121 and 131), respectively (in the case of the first cap plate assembly (120), a first outer insulating plate (123b) may be placed on one surface of the first cap plate (121) together with the terminal plate (122)), and then fitting the first and second connection members (124 and 134) into the through-holes formed by the components. The first and second connection members (124 and 134) may be fixed in a state of being fitted into the through-holes without separate welding.

The assembled first and second cap plate assemblies (120 and 130) may be connected to the anode tab (12a) and the cathode tab (13a), respectively, and may be coupled to both sides of the case (110) in the longitudinal direction, to close the case (110). The first and second cap plate assemblies (120 and 130) may be joined to the case (110) by laser welding in a state where they are disposed to cover both sides of the case (110) in the longitudinal direction. The first and second cap plate assemblies (120 and 130) may be joined to the case (110) by laser welding in a state where they are disposed to cover both sides of the case (110) in the longitudinal direction. The first and second connection members (124 and 134) may be in contact with and supported by the two end tabs (12a and 13a) in a state in which the first and second cap plate assemblies (120 and 130) are disposed to close both sides of the case (110) in the longitudinal direction, and the elastic parts (1241 and 1341) may be compressed in the longitudinal direction of the case (110). Accordingly, the first and second terminal plates (122 and 132) and the two end tabs (12a and 13a) may be connected to each other, and separate welding is not required. In addition, the electrode assembly (10) may be fixed by adjusting the pressure value applied to the two end tabs (12a and 13a) by changing the number and/or specifications of the elastic parts (1241 and 1341).

Meanwhile, the first and second cap plate assemblies (120 and 130) may be provided with a stopper (150) that seals the electrolyte injection port. The electrolyte may be injected into the internal space of the case (110) through the electrolyte injection port.

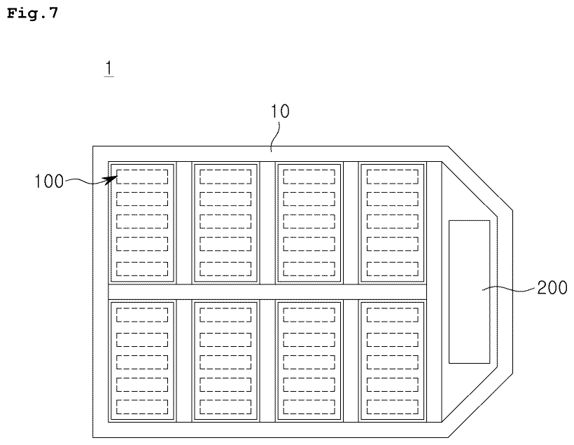

FIG. 7 is a drawing schematically illustrating an energy storage device including a secondary battery cell according to an embodiment of the present disclosure.

Referring to FIG. 7, an energy storage device (1) may include a plurality of secondary battery cells (100). As illustrated in FIG. 7, the energy storage device (1) may be a battery pack, but is not limited thereto. For example, the energy storage device (1) may be a unit smaller than a battery pack, for example, may also be a battery module.

Referring to FIG. 7, the energy storage device (1) may include a housing (10) having a space in which a plurality of battery cells (100) are accommodated. For example, a plurality of battery cells (100) disposed in each of partitioned spaces of the housing (10) may become one battery module. In addition, a battery management system (BMS) (200) that controls a plurality of battery cells (100) or battery modules may be disposed in one side of the housing (10). Although not illustrated in the drawing, a cover may be coupled to the upper part of the housing (10).

As described above, according to embodiments of the present disclosure, the number of welding required during the assembly process of the secondary battery cell (100) is reduced, thereby simplifying the manufacturing process and minimizing defects caused by welding.

Although the configuration and features of the present disclosure have been described above based on embodiments according to the present disclosure, the present disclosure is not limited thereto, and it is obvious to those skilled in the art that various changes or modifications may be made within the spirit and scope of the present disclosure, and therefore it is made clear that such changes or modifications fall within the scope of the appended patent claims.

1. A secondary battery cell comprising:
a case forming an internal space;
an electrode assembly including an anode plate, a cathode plate, and a separator interposed between the anode plate and the cathode plate, and disposed in the internal space; and
a cap plate assembly coupled to at least one side of the case,
wherein the electrode assembly includes an anode tab and a cathode tab extending in one direction from the anode plate and the cathode plate, respectively, and
the cap plate assembly includes a connection member electrically connected to the anode tab or the cathode tab, and including an elastic part.

2. The secondary battery cell of claim 1, wherein the elastic part has elasticity in a direction in which the cap plate assembly is coupled to the case.

3. The secondary battery cell of claim 1, wherein the elastic part is provided as one or more coil springs or plate springs.

4. The secondary battery cell of claim 1, wherein the cap plate assembly includes,
a cap plate coupled to the case;
a terminal plate disposed on one side of the cap plate; and
an insulating plate disposed on at least one side of one surface and the other surface of the cap plate, and
the connection member is disposed to penetrate through the cap plate, the terminal plate, and the insulating plate.

5. The secondary battery cell of claim 4, wherein the terminal plate is electrically connected to the anode tab or the cathode tab through the connection member.

6. The secondary battery cell of claim 5, wherein the connection member includes a first portion forming contact with the elastic part and the terminal plate.

7. The secondary battery cell of claim 6, wherein the connection member further includes a second portion forming contact with the elastic part and the anode tab or the cathode tab.

8. The secondary battery cell of claim 5, wherein the cap plate assembly further includes a sealing member disposed between the cap plate and the connection member.

9. The secondary battery cell of claim 5, wherein the cap plate, the terminal plate, and the insulating plate include a through-hole in which the connection member is disposed, and
the connection member is fitted into the through-hole.

10. The secondary battery cell of claim 5, wherein the cap plate assembly includes:
a first cap plate assembly disposed on one side of the case in a longitudinal direction and including a first terminal plate electrically connected to the anode tab; and
a second cap plate assembly disposed on the other side of the case in the longitudinal direction and including a second terminal plate electrically connected to the cathode tab.

11. An energy storage device comprising a plurality of the secondary battery cells of claim 1,
wherein the plurality of secondary battery cells are electrically connected.

12. The energy storage device of claim 11, wherein the elastic part is provided as one or more coil springs or plate springs.

13. The energy storage device of claim 11, wherein the cap plate assembly includes,
a cap plate coupled to the case;
a terminal plate disposed on one side of the cap plate; and
an insulating plate disposed on at least one side of one surface and the other surface of the cap plate,
wherein the connection member is disposed to penetrate through the cap plate, the terminal plate, and the insulating plate.
